(19) United States
(12) Patent Application Publication
(10) Pub. No.: US 2013/0173709 A1
(43) Pub. Date: Jul. 4, 2013

(54) CLOUD-BASED CONTENT MIXING INTO ONE STREAM

(71) Applicant: Gface GmbH, Frankfurt/Main (DE)

(72) Inventor: Cevat Yerli, Frankfurt/Main (DE)

(73) Assignee: GFACE GMBH, Frankfurt/Main (DE)

(21) Appl. No.: 13/729,007

(22) Filed: Dec. 27, 2012

Related U.S. Application Data
(60) Provisional application No. 61/581,227, filed on Dec. 29, 2011.

(51) Int. Cl. H04L 29/06

(52) U.S. Cl. CPC H04L 65/4069
USPC 709/204

(57) ABSTRACT

A network-based system of providing a combined single data stream to at least one user device or user group device, the system including a computing cloud receiving different data from a plurality of data sources and generating from said data a single data stream to be provided to at least one remote user or user group; at least one user device or user group device having access to the computing cloud for receiving said combined single data stream to be outputted for the at least one remote user or user group.

### CROSS-REFERENCE TO RELATED APPLICATION

This application claims the benefit of U.S. Provisional Patent Application No. 61/581,227, filed Dec. 29, 2011, the disclosure of which is incorporated by reference herein in its entirety.

### FIELD

The present disclosure relates to a network-based system and to a method of providing a combined single data stream to at least one user or user group.

### BACKGROUND

There are known network-based systems and method for providing cloud computing to a plurality of clients such as mobile devices. Such a system is described in U.S. Pre-Grant Patent Publication 2010/0257252 A1.

Typically, current systems that render several media streams for a viewer do so on the viewer's own client machine. For example, a browser installed on a user's PC or mobile device renders videos, audio files, and the like using the computation power available on the client machine. Such a system is described in U.S. Pre-Grant Patent Publication 2009/0288019 A1. This technique automatically sets a limit of what can be displayed and in what quality. Therefore the quality might be not sufficient for an optimal experience of the content.

### SUMMARY

The present disclosure relates to a network-based system and to a method of providing a combined single data stream to at least one user or user group. In particular, the present disclosure relates to a network-based system and to a method of computing, in particular rendering, different media data for generating said single data stream, wherein the media data may come from different data sources such as game servers, ad servers, and/or the like. In particular, the disclosure relates to a system and to a method that enables the mixing or combining of two or more multimedia streams into a single stream, via a cloud-based rendering.

According to a first aspect of the disclosure there is described a network-based system configured to provide a combined single data stream to at least one user device or user group device, the system comprising:

a computing cloud configured to receive different data from a plurality of data sources and generate from said data a single data stream to be provided to at least one remote user or user group; and

equipment such as at least one user device or user group device having access to the computing cloud and configured to receive said combined single data stream to be outputted for the at least one remote user or user group.

According to a second aspect of the disclosure there is described a method of providing a combined single data stream to at least one user device or user group device within a network-based system, the method comprising the steps of:

receiving at a computing cloud different data from a plurality of data sources;

generating from said data a single data stream to be provided to at least one remote user or user group; and

receiving at the at least one user device or user group device said combined single data stream to be outputted for the at least one remote user or user group.

The described systems and methods use a rendering cloud to compute the stream online, before transferring the rendered data to the client device. This way, the quality of the content is less restricted and can be more readily provided at a premium level (or any quality level desired by the content provider). The structure of the cloud provides a consistent high level of performance through the distributed nature of the cloud server(s).

The content itself can be any multimedia content, such as audio, 2D or 3D video, still pictures, animations, and others. The content can be delivered in different forms, including advertisements, and a particular content item can include different types of multimedia content. For example, an advertisement can include audio and video content. It can also be interactive in its presentation, although this does not have to be the case. Thus, the different data may comprise media data, in particular video, audio, still images, and/or graphics, from said plurality of data sources, and the computing cloud renders said different data for generating said single data stream to be provided to the at least one remote user.

The plurality of data sources may comprise media data servers and/or sources, in particular game servers and/or ad servers. The computing cloud may comprise a plurality of cloud servers, in particular media renderers, performing the data computations, in particular the rendering of media data, to provide said single data stream. The plurality of cloud servers may perform said data computations according to at least one stream build list provided by a service and/or by said data sources. Moreover, the plurality of cloud servers may perform said data computations for a predefined quality of service independently from any condition and/or characteristic of the user device's display.

The term “stream build list” shall define a list of logical media or other items that are comprising the stream. The list also contains additional metadata that defines where the logical media items are placed in the stream, in terms of time and space. The list can be, but does not have to be, formatted as an XML file listing all elements with their parameters. This list is the structure that is used by the system to generate one stream from the single files.

In one embodiment, the plurality of cloud servers generates said single data stream to be provided to a plurality of user devices. In another embodiment, the plurality of cloud servers generates individually for a plurality of users or groups of users several single data streams to be provided individually to the users and/or groups of users.

The at least one user device may comprise at least one client computer or terminal being connected via a network, in particular an IP network, to said plurality of cloud servers. Preferably, the at least one user device interacts with said plurality of cloud servers to modify the provided single data stream. The plurality of cloud servers may provide said modified single data stream to several user devices only if said user devices interact with said plurality of cloud servers to indicate the same choice of modification.

The described method of providing said combined single data stream may further comprise at least one of the following steps:

requesting a computation, in particular a rendering, of said different data for generating said single data stream;

generating said single data stream according to a stream build list provided by a service and/or by said data sources;

transmitting via a network, in particular an IP network, said single data stream to the at least one user device which in particular is a client device; and/or

displaying the data stream at the at least one user device which in particular is a client device.

### DESCRIPTION OF THE DRAWINGS

Further features and advantages of the present disclosure, as well as the structure and operation of various illustrative embodiments of the present disclosure, are described in detail below with reference to the accompanying schematic drawings, wherein:

FIG. 1 shows a system structure for a first embodiment of a system according to the present disclosure;

FIG. 2 shows a functional diagram for a second embodiment of a system according to the present disclosure;

FIG. 3 shows a functional diagram for a third embodiment of a system according to the present disclosure; and

FIG. 4 shows a flow chart for implementing said embodiments of the present disclosure.

### DETAILED DESCRIPTION

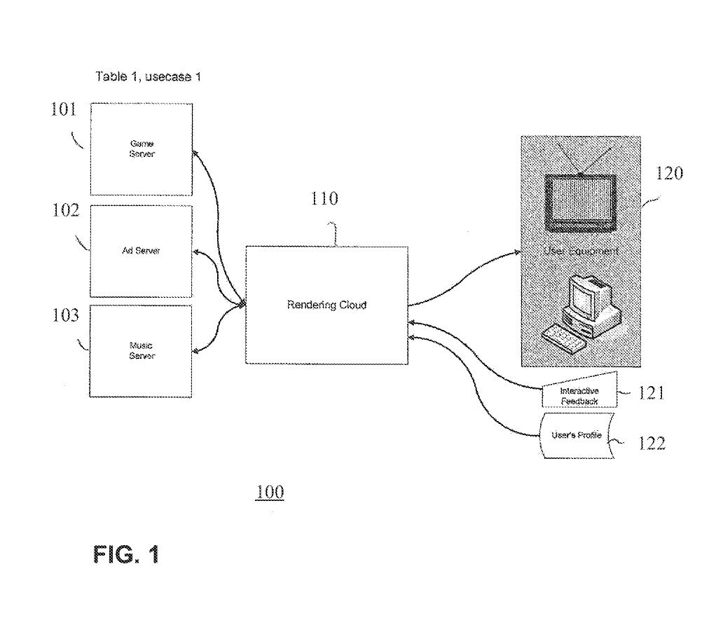

As shown in FIG. 1, the described system 100 uses a rendering cloud 110 to compute the stream online, before transferring the rendered data to equipment such as the user devices 120. This way, the quality of the content is more readily provided at a premium level (or any quality level desired by the content provider). The structure of the cloud 110 provides a consistent high level of performance through the distributed nature of the cloud server(s). In operation, the rendering cloud 110 may process interactive feedback data 121 or user profile data 122. For example, the rendering cloud may select or customize the presentation of content items based on interactive feedback data 121 or user profile data 122.

The content itself can be any media data, in particular multimedia data, such as audio, 2D or 3D video, still pictures, animations, and others. The content can be delivered in different forms, including advertisements, and a particular content item can include different types of multimedia content. For example, an advertisement can include audio and video content. It can also be interactive in its presentation, although this does not have to be the case. The media data can come from different data sources such as game servers 101, ad servers 102, music servers 103, and the like.

Rendering of the stream is performed as follows:

The system 100 gets the necessary data from connected data servers 101-102, together with the stream build list that defines the order and composition of the individual content items. In addition, the stream is compressed with codecs as requested by the stream build list; for instance, depending on the supported codecs on the client device, the stream is encoded with the preferred codec.

FIG. 1 shows the general structure of a system according to the present disclosure. The system allows multiple source files to be combined into a single data stream.

In an example scenario, a user has a browser open with the following items active: he is playing a game, a music file is being played back, and an advertisement is shown in an ad frame. All these individual content items are combined on the server and streamed as a single video and audio stream to the user.

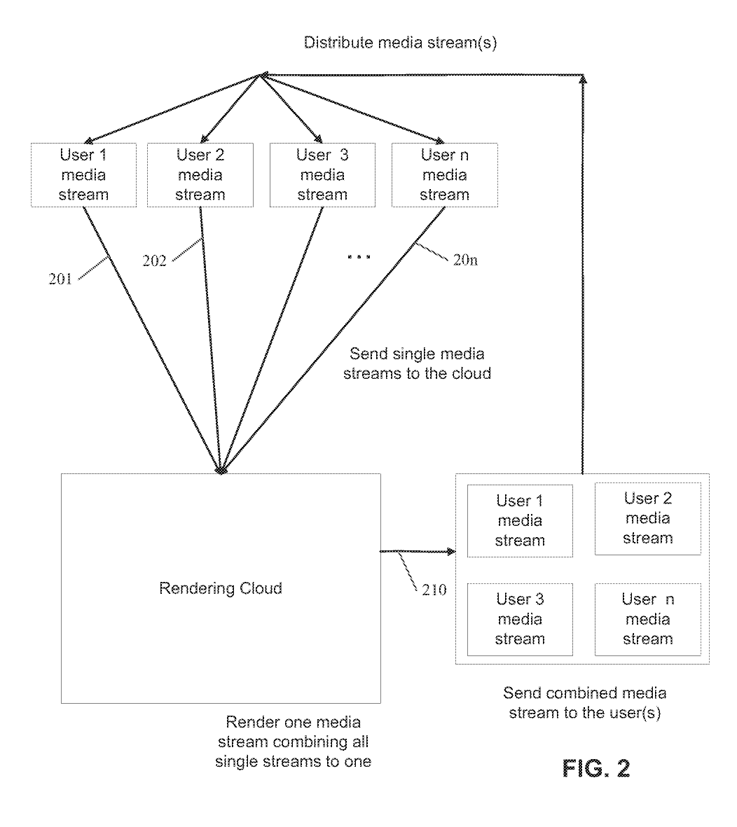

FIG. 2 shows a functional diagram for a system and method which provides a data stream 210 combining input media data such as media streams 201, 202, and 20n to one user who has the option of changing view modes.

In one example scenario, the user is watching videos online. Several videos are played simultaneously in frames next to each other. These videos are streamed as one video from the server. The user switches to a different view where the videos are stacked behind each other, slightly overlapping (stacking the videos such that the videos are arranged at different depths in the stack). The animation of moving from one view mode (videos next to each other) to the other (stacked view) is calculated on the server while the videos keep running. In the stacked view, the videos are still running.

Optionally, the view can be switched to a stereoscopic 3D view rendered on the server cloud.

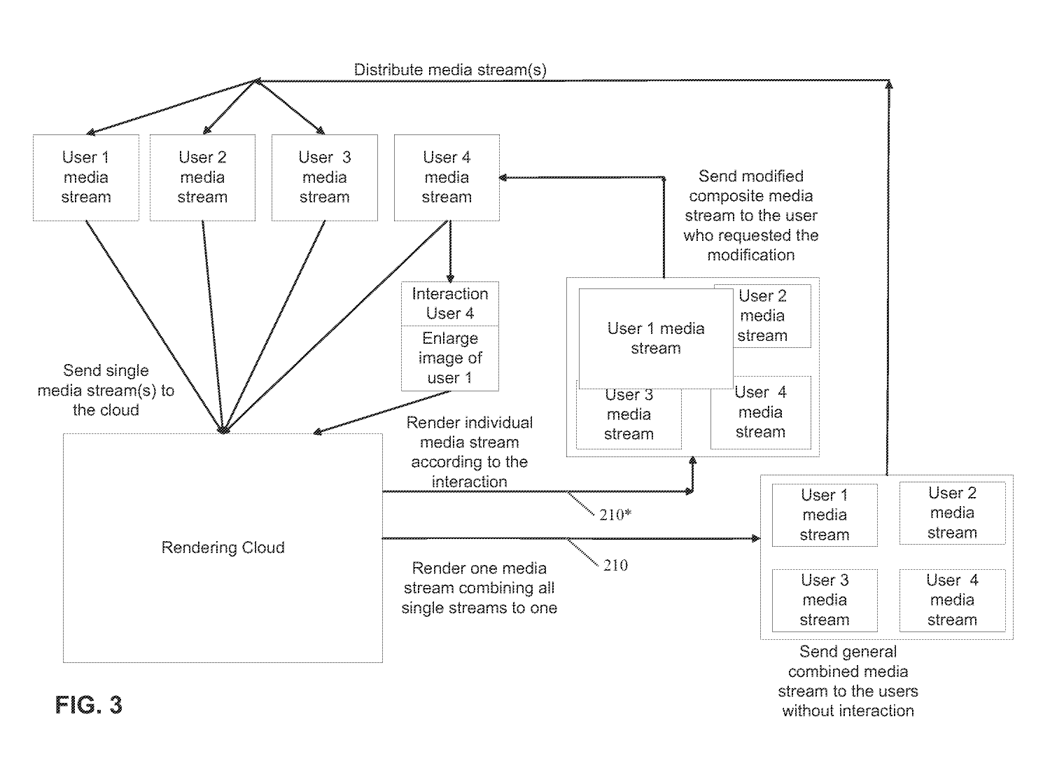

FIG. 3 shows another functional diagram which illustrates the feature of rendering individual media stream 210*. This can be used, for example, in an in-game advertisement. In an example scenario, the user is playing a game that supports in-game advertisement. Inside the game, ad-boards are prominently placed. A texture is projected inside the game on these ad-boards. The texture is streamed from the server cloud to the game while the game is running. The game receives the stream as a texture that is automatically placed inside the game on the appropriate object (e.g., an ad-board) without performance degradation, independent from the displayed content.

In another embodiment, the system and method can provide a video conference stream: Many users (e.g., “User 1,” “User 2,” “User 3,” “User 4”) may want to join one video conference from different locations, using video cameras for their source video. Each user is filmed by his separate video camera and streams his video stream to the server(s) in the rendering cloud.

Inside the cloud all videos are by default combined to one default video stream, displaying every user (up to a certain amount) as a tiled video frame, e.g., 16 single video streams are tiled as 4 by 4 smaller video streams into one video stream), significantly reducing the required download bandwidths per user (see FIGS. 2 and 3).

Each user can now interact with the default video stream and demand a certain video be displayed enlarged inside the composited video. This request is sent to the server cloud and the stream to this specific user will be modified to his liking (see FIG. 3). The system can switch between the default stream and an individualized stream for each user at any time and, in case the individualized stream is applicable to more or all users, that stream can be shared to a group of users or all users.

The interaction is not limited to changing the size. All typical manipulations of multimedia streams are possible, for example, color changes, contrast or brightness, audio volume, and others.

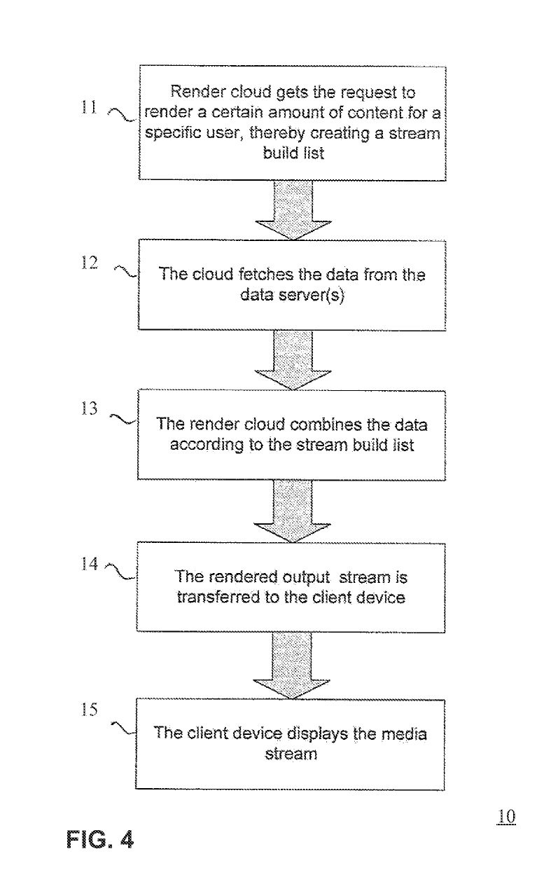

FIG. 4 shows a flow chart of a method 10 of providing a combined data stream. In a first step 11, the rendering cloud receives a request to render a certain amount of content (media data) for a specific user, thereby creating a stream build list. In a second step 12, the rendering cloud receives the different media data from the sources (data servers). Then, in a third step 13, the rendering cloud combines the data according to the stream build list. Afterwards, in step 14, the rendered output stream is transmitted/transferred to the client device (user device). Finally, in step 15, the client device outputs (displays) the media stream.

In this way, the system may generate a combined video/audio stream from any media content that may contain video, audio, still images, graphics, and other media sources. All computations are done on the server side in the server cloud.

The renderer (rendering cloud) is able to combine/mix different content sources into one stream and can do this individually for any user or user group.

The quality of the stream combination is independent of the client's display device.

The supplied video stream can be modified interactively by the user. That interactive stream can or would be served to the user only who does the interaction or served to more than one user if more users have same interaction choices.

While illustrative embodiments have been illustrated and described, it will be appreciated that various changes can be made therein without departing from the spirit and scope of the invention.

The embodiments of the invention in which an exclusive property or privilege is claimed are defined as follows:

1. A network-based system of providing a combined single data stream to at least one user device or user group device, the system comprising:
a computing cloud configured to receive different data from a plurality of data sources and generate from said data a single data stream to be provided to at least one remote user or user group; and
at least one user device or user group device having access to the computing cloud and configured to receive said combined single data stream to be outputted for the at least one remote user or user group.

2. The network-based system of claim 1, wherein the different data comprises media data from said plurality of data sources, and wherein the computing cloud renders said different data for generating said single data stream to be provided to the at least one remote user or user group.

3. The network-based system of claim 2, wherein the media data comprises video, audio, still images, and/or graphics.

4. The network-based system of claim 1, wherein the plurality of data sources comprises media data servers and/or sources.

5. The network-based system of claim 4, wherein the media data servers comprise a game server and/or an ad server.

6. The network-based system of claim 1, wherein the computing cloud comprises a plurality of cloud servers configured to perform data computations to provide said single data stream.

7. The network-based system of claim 6, wherein the plurality of cloud servers comprises a media renderer.

8. The network-based system of claim 6, wherein the data computations comprise rendering of media data.

9. The network-based system of claim 6, wherein the plurality of cloud servers is configured to perform said data computations according to at least one stream build list provided by a service and/or by said data sources.

10. The network-based system of claim 6, wherein the plurality of cloud servers is configured to perform said data computations for a predefined quality of service independently from any condition and/or characteristic of a display of the at least one user device or user group device.

11. The network-based system of claim 6, wherein the plurality of cloud servers is configured to generate said single data stream to be provided to a plurality of user devices.

12. The network-based system of claim 6, wherein the plurality of cloud servers is configured to generate individually for a plurality of users or groups of users several individual data streams to be provided individually to the users and/or groups of users.

13. The network-based system of claim 6, wherein the at least one user device or user group device comprises at least one client computer or terminal being connected via a network to said plurality of cloud servers.

14. The network-based system of claim 13, wherein the network is an IP network.

15. The network-based system of claim 6, wherein the at least one user device or user group device is configured to interact with said plurality of cloud servers to modify the provided single data stream.

16. The network-based system of claim 15, wherein the plurality of cloud servers is configured to provide said modified single data stream to several user devices only if said user devices interact with said plurality of cloud servers to indicate the same choice of modification.

17. A method of providing a combined single data stream to at least one user device or user group device within a network-based system, the method comprising the steps of:
receiving at a computing cloud different data from a plurality of data sources;
generating from said data a single data stream to be provided to at least one remote user or user group; and
providing to at least one user device or user group device said combined single data stream to be outputted for the at least one remote user or user group.

18. The method of claim 17, further comprising at least one of the following steps:
requesting a rendering of said different data for generating said single data stream;
generating said single data stream according to a stream build list provided by a service and/or by said data sources;
transmitting via an IP network said single data stream to the at least one user device or user group device which in particular is a client device; and/or
displaying the data stream at the one user device or user group device which in particular is a client device.
